(19) United States
(12) Patent Application Publication
(10) Pub. No.: US 2024/0165828 A1
(43) Pub. Date: May 23, 2024

(54) APPARATUS AND METHOD FOR HORIZONTAL UNLOADING WITH AUTOMATED ARTICULATED ARM, MULTI-ARRAY GRIPPING, AND COMPUTER VISION BASED CONTROL

(71) Applicant: Plus One Robotics, Inc., San Antonio, TX (US)

(72) Inventors: Matthew Churchill, San Antonio, TX (US); Wayne Kirk, San Antonio, TX (US); Christopher Naville, San Antonio, TX (US); Charles Costello, Westminster, CO (US); Paul Hvass, San Antonio, TX (US)

(21) Appl. No.: 18/384,845

(22) Filed: Oct. 28, 2023

Related U.S. Application Data
(60) Provisional application No. 63/420,301, filed on Oct. 28, 2022.

(51) Int. Cl. B25J 15/06; B25J 15/00

(52) U.S. Cl. CPC B25J 15/0616; B25J 15/0014; B25J 15/0028

(57) ABSTRACT

An end effector for attaching to a robotic arm includes a gripper fixedly attached to a carriage, and a platform. The gripper is configured for being in fluid communication with a vacuum source. The platform has a distal end and a proximal end that is configured for being coupled to the robotic arm. The carriage is operatively coupled to the platform and is configured to move back and forth between the distal and proximal ends of the platform. The gripper may include a plurality of suction cups configured for engaging a package, and the carriage may be configured for lifting the gripper and dragging the package onto the platform while the package is engaged by the gripper.

### CROSS-REFERENCE TO RELATED APPLICATIONS

This application claims priority to U.S. Provisional Patent Application Ser. No. 63/420,301, filed Oct. 28, 2022, entitled “Apparatus And Method For ULD Unloading With Automated Articulated Arm, Multi-Array Gripping, And Computer Vision Based Control,” the entire contents of which are incorporated herein by reference.

### BACKGROUND

### Field of the Art

This invention relates to a pneumatic vacuum gripping system and automated control system for unloading a pallet or container, such as a unit load device (ULD). More particularly, the pneumatic gripping system may have an articulated arm, an end effector having a gripper operatively coupled to a platform, and computer vision based control.

### Discussion of the State of the Art

A unit load device (ULD) is a container used to load luggage, freight, packages, mail, and the like on aircraft. Cargo is pre-loaded onto the ULD and then the entire ULD is loaded onto the aircraft. Currently, unloading a ULD requires human intervention. For example, the ULD may be unloaded manually by hand, or by using a truck-based extractor. As such, unloading a ULD requires expensive person hours and may result in human error and/or injuries.

Robotic assisted unloading of ULDs poses challenges typical robotic loading/unloading systems are generally not equipped to handle. For example, given the nature of ULDs, unloading generally must occur in a horizontal fashion where objects in the ULD are accessed from a side orientation as opposed to conventional robot assisted unloading, such as robot aided depalletization in a warehouse. Furthermore, given space constraints inside the ULD, maneuverability of a robotic arm within the ULD is generally more constrained than in an open environment, potentially limiting the order in which objects may be accessed in order to be manipulated and/or unloaded. Mobile manipulators, such as the mobile robotic arm Stretch™ developed by Boston Dynamics may be used to unload ULDs, thereby avoiding many of the disadvantages associated with manually unloading ULDs. However, these mobile manipulators are configured to move back and forth between the ULD and the unloading area, and are thus expensive to make and maintain. Further, currently available mobile manipulators do not integrate well with existing conveyance systems.

As such, there is a need for an automated system for unloading ULDs in a horizontal fashion that is stationary, affordable, and integrates well with existing conveyance systems.

### SUMMARY

The present invention is directed to an apparatus and automated methods for unloading containers of individual items that vary in size, composition, and packaging. For example, the apparatus and methods may be used to unload packages in a ULD from an airplane, a cage-cart, gaylord, shipping container, truck, or the like. The apparatus includes a multi-zone vacuum-based gripper on the end of an articulated arm, controlled by an autonomous computer vision system.

The computer vision system identifies the various packages, determines the order in which they should be picked, and plans pick paths that avoid physical restrictions in the environment (e.g., the lip that frames the ULD). The gripper has multiple zones, which may be individually activated and/or individually articulated. The zones attach to the target package(s) from the side and execute a “lift and drag” motion to pull the package(s) onto a flat spatula or platform for transport. The independent zones allow for various package sizes to be accommodated, as well as multiple packages of different sizes to be grabbed at the same time. The gripper may comprise a plurality of suction cups and extendable arms that expand and compress independent of each other. As such, the gripper is configured to pick packages from various depths at the same time. The spatula may include additional degrees of freedom (e.g., conveyor belt, fingers, etc.) to assist with pulling the packages on and/or holding the packages in place during transit.

Packages are ordered for picking by taking into account physical constraints, such as the fact that upper packages must be picked before lower packages that they lie on, and that center packages must be picked before outer packages to give the outer packages space to navigate within the container and avoid the peripheral container lip when being pulled out. Likewise, the gripping and extraction paths for the arm are autonomously planned around such obstacles. A lightweight simulator/heuristics is used to rank packages for picking, theoretically remove the best package, re-rank the remaining packages, etc. A remote human-in-the-loop system serves as backup for the system's autonomy. At any point, for any decision, if the system is unable to produce an answer, it can ask a human to provide one, which is then used to train the system. Sub-tasks that can be delegated to a human include identifying packages, ordering the picks, and determining correct approach/extraction paths. Lastly, there is the option for the arm (or a secondary autonomous system) to drag a movable conveyance system into a horizontal storage system (ULD, truck, or the like) and place it under the active space to reduce the distance packages must be transported by the arm (and catch anything that falls).

In one example, the present invention is an end effector configured for attaching to a robotic arm. The end effector includes a gripper configured for being in fluid communication with a vacuum source. The end effector further includes a carriage, wherein the gripper is coupled to the carriage. Still further, the end effector includes a platform having a distal end and a proximal end. The proximal end of the platform is configured for being coupled to the robotic arm. The carriage is operatively coupled to the platform and is configured to move back and forth between the distal and proximal ends of the platform.

The carriage may be further configured to move the gripper upwards relative to the platform so that the gripper is in a lifted position relative to the platform. In this example, the carriage may include an actuator that is configured to move the gripper upwards to the lifted position. The actuator may include a pneumatic air cylinder and/or a servo motor. In one example, the actuator may include a plurality of pneumatic air cylinders that are configured to extend to move the gripper upwards to the lifted position.

The gripper may include a plurality of suction cups coupled to a respective plurality of extendable arms. The extendable arms may be configured to extend and retract relative to the carriage. The gripper may be configured for engaging a package, and the carriage may be configured for dragging the package onto the platform while the package is engaged by the gripper. The carriage may additionally be configured for lifting the gripper and dragging the package onto the platform while the package is engaged by the gripper.

The platform may include a track and the carriage may be operatively coupled to the track so that the carriage moves back and forth within the track.

### BRIEF DESCRIPTION OF THE DRAWING FIGURES

The accompanying drawings, which are incorporated in and constitute a part of this specification, illustrate certain aspects of the instant invention and together with the description, serve to explain, without limitation, the principles of the invention. Like reference characters used therein indicate like parts throughout the several drawings.

FIG. 1 illustrates an exemplary system for automated unloading of containers in accordance with an exemplary embodiment of the invention.

FIG. 2 illustrates an exemplary container (e.g. ULD) of objects to be unloaded.

FIGS. 3A and 3B are perspective views of an exemplary robot picking unit having a gripper in an extended position and a retracted position, respectively, in accordance with one embodiment of the present invention.

FIGS. 4A and 4B are a front plan view and a top plan view, respectively, of a gripper and associated carriage assembly in accordance with one embodiment of the present invention.

FIGS. 5A-5D illustrate a robotic picking unit at various stages during an unloading process, in accordance with one embodiment of the present invention.

FIG. 6 illustrates an exemplary unloading station in accordance with one embodiment of the present invention.

FIG. 7 illustrates an exemplary vision system for use in an automated robotic picking system in accordance with an exemplary embodiment of the present invention

FIG. 8 illustrates an exemplary process for computing a pick plan and providing pick instructions according to one embodiment of the present invention.

FIG. 9 illustrates one embodiment of the computing architecture that supports an embodiment of the inventive disclosure.

FIG. 10 illustrates components of a system architecture that supports an embodiment of the inventive disclosure.

FIG. 11 illustrates components of a system architecture that supports an embodiment of the inventive disclosure.

FIG. 12 illustrates components of a computing device that supports an embodiment of the inventive disclosure.

### DETAILED DESCRIPTION

The present invention is for an end effector configured for being coupled to a robot picking unit. The end effector includes a gripper operatively coupled to a platform. The gripper is configured to move back and forth relative to the platform. In one example, the gripper is additionally configured to move upwards relative to the platform in order to lift and drag a package onto the platform. The robot picking unit is programmed and configured for unloading a ULD in a horizontal manner. The base of the robot picking unit may be stationary relative to the ULD and may be configured for unloading packages from the ULD and moving the packages to a desired location, such as a conveyor belt.

The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the terms “optional,” “optionally,” or “preferably” mean that the subsequently described event or circumstance may or may not occur, and that the description includes instances where said event or circumstance occurs and instances where it does not.

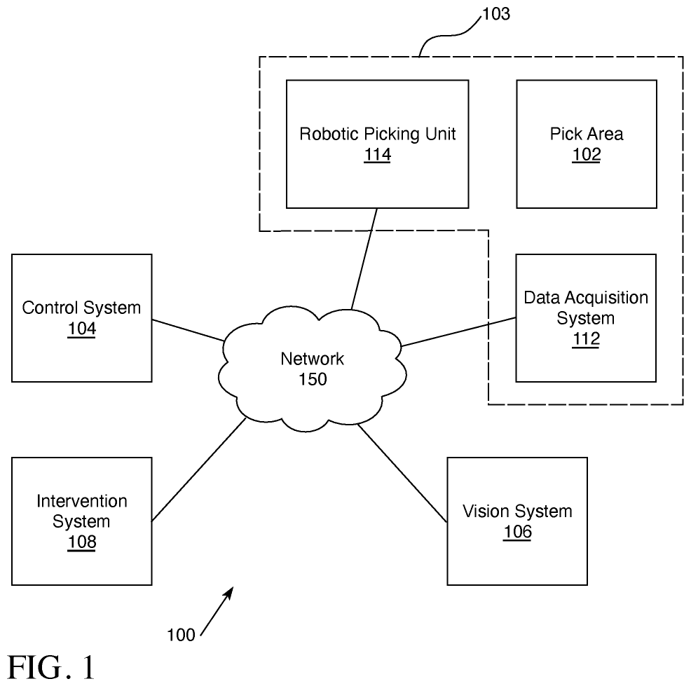

Referring now to the drawings, where like reference numbers correspond to like or similar components throughout the several figures, FIG. 1 illustrates an exemplary system 100 for automated unloading (or loading) of containers. The exemplary system 100 includes at least pick area 102, robotic picking unit 114, data acquisition system 112, vision system 106, intervention system 108, control system 104, and network 150 over which the various systems communicate and interact.

In the exemplary embodiment, pick area 102, robotic picking unit 114, data acquisition system 112 may be located at the same robotic picking site 103 while other components may be remote and in communication over network 150. This is merely exemplary and other systems may be included at robotic picking site 103 as would be apparent to one of ordinary skill in the art. Moreover, robotic picking site 103 may be representative of a plurality of different robotic picking sites situated at varying locations (e.g. a plurality of unloading bays, one or more warehouses, etc.) each comprising a corresponding robotic picking unit 114, pick area 102, and data acquisition system 112.

As a general overview, in an exemplary automated robotic picking application (e.g. unloading of a container), a vision system 106 processes data associated with a pick area 102 (e.g. a container) in order to determine picking operations to be performed by a robotic picking unit 114. The vision system 106 may process data obtained from a data acquisition system 112, such as image data and/or three-dimensional depth data as part of determining picking operations. In one aspect, an intervention system 108 may serve to provide human-in-the-loop interventional assistance such as in scenarios where the vision system 106 is unable to identify, automatically or with sufficient confidence, suitable picking operations for a given scenario. A control system 104 may obtain information from one or more other system components for determining control information for use by robotic picking unit 114.

Pick area 102 generally comprises a container comprising objects to be unloaded (e.g. boxes, bags, non-uniform packages, etc.). Objects to be unloaded may be present in an orderly configuration (e.g. stacked boxes of similar size/shape) and/or a configuration lacking order (e.g. varying shapes, sizes, objects positioned at angles, etc.). In one aspect, pick area comprises a unit load device (ULD), box truck/van, or other container where access to and observation of objects within the container is generally limited to side or horizontal access and/or observation where overhead/vertical access and/or observation is either not possible or presents significant obstruction and/or challenge for conventional robotic picking systems. Furthermore, ULDs generally comprise a lip around the opening of the container which may often cause an obstruction preventing an object from being pulled directly out of the container along a horizontal direction as such an approach would result in the object colliding with the lip of the container. Pick area 102 may additionally or alternatively comprise placement sites (e.g. containers, conveyor belts, etc.) where objects (e.g. unloaded from a container) are to be moved to for further handling, storage, and/or distribution as appropriate.

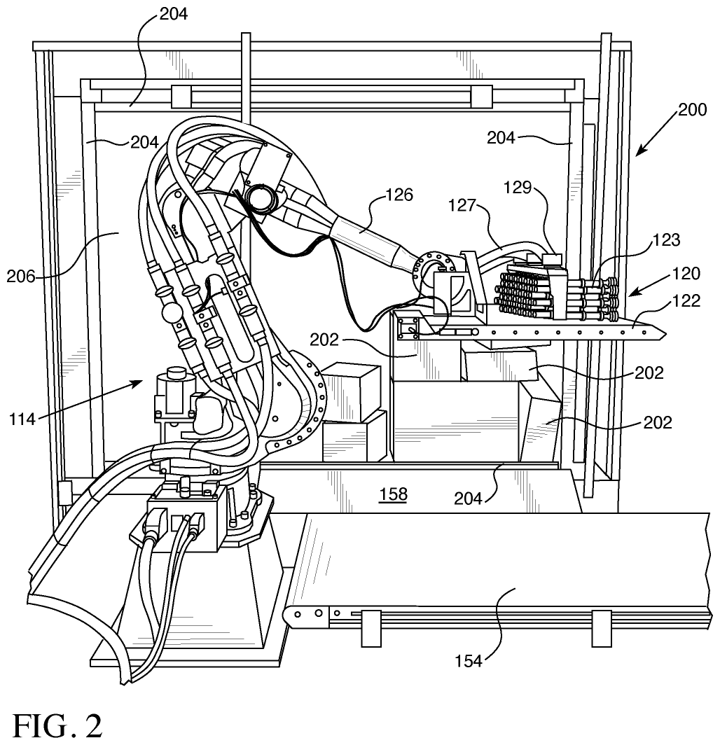

One example of a ULD is shown in FIG. 2. The ULD 200 is a container used for shipping packages or other types of cargo. As shown in FIG. 2, the ULD 200 is loaded with packages 202 in a disordered manner. The packages 202 are all different sizes, shapes, and weights, and are unloaded in a horizontal direction due to the configuration of the ULD. The ULD 200 has a lip 204 around the periphery of the opening 206. Some of the packages 202 are tucked behind the lip 204 and thus cannot be directly removed in the horizontal direction. Rather, the packages 202 tucked behind the lip 204 must be moved laterally away from the lip 204 and then pulled out horizontally and/or must be lifted up and over the lip 204 at the bottom of the ULD 200.

An example of a robotic picking unit 114 configured for unloading a ULD 200 in accordance with the present invention is also depicted in FIG. 2. The robotic picking unit 114 includes an end effector 120 attached to the end of a robotic arm 126. The end effector 120 includes a gripper 123 and a platform 122. The gripper 123 is configured for engaging packages 202 and dragging the packages 202 onto the platform 122 so that the platform 122 supports the weight of the packages 202 while the packages 202 are being moved from the ULD 200 to the place area (e.g., conveyor belt 154).

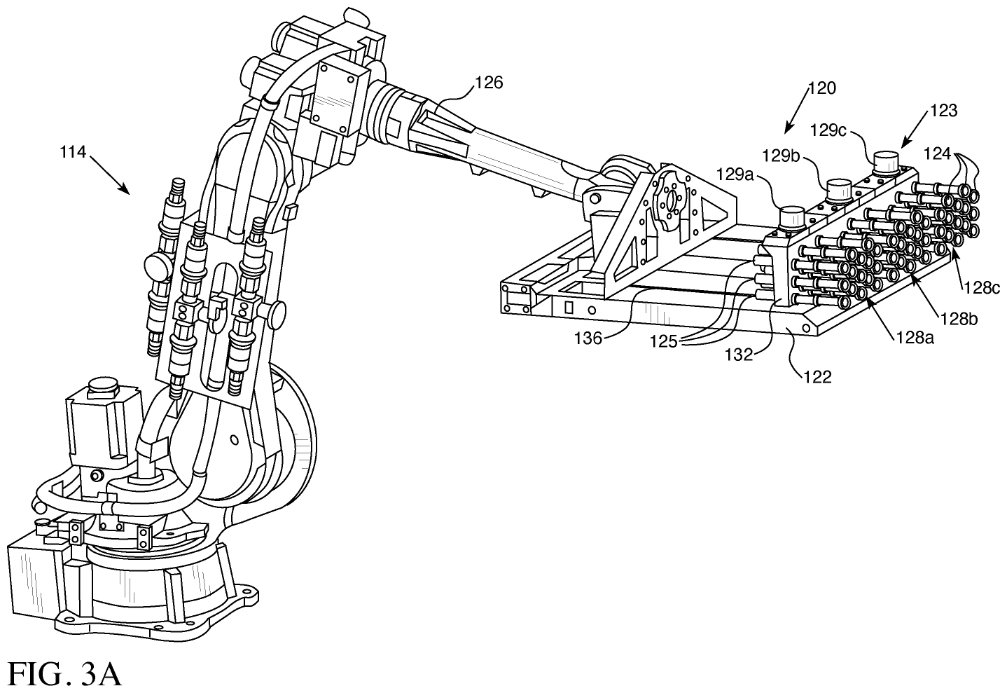

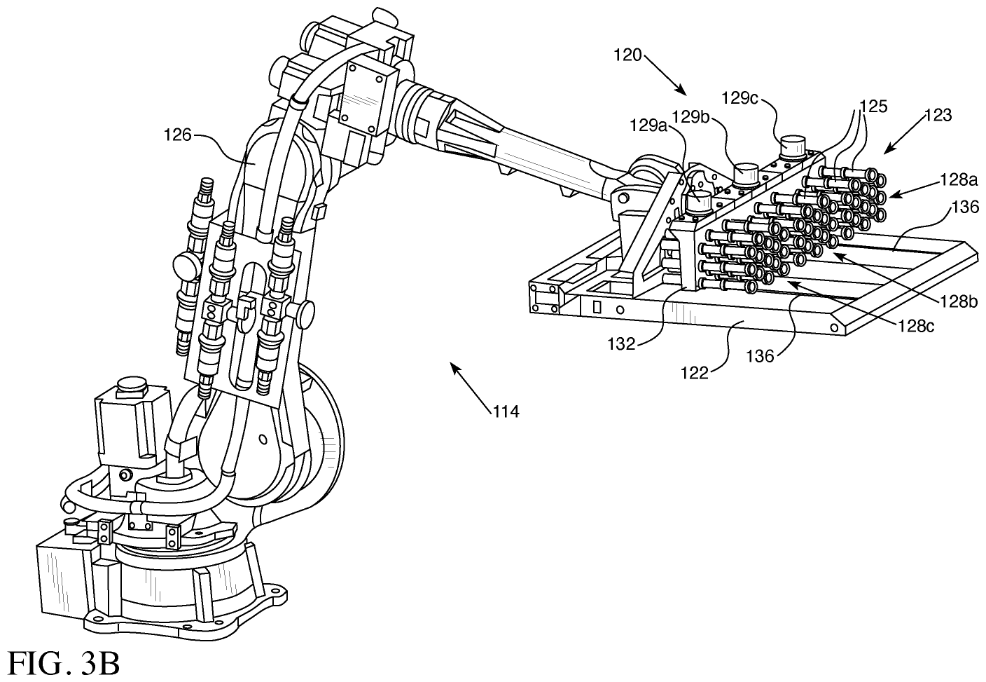

The robotic picking unit 114 is discussed in more detail with reference to FIGS. 3A and 3B. The end effector 120 of the robot picking unit 114 is attached to the end of the articulated arm 126. The end effector 120 includes a gripper 123 and a spatula or platform 122. In this example, the gripper 123 includes a plurality of suction cups 124. The plurality of suction cups 124 are divided into three arrays 128a, 128b, 128c, where each array 128 includes several suction cups. It should be readily understood that the present invention is not limited to three arrays 128, and that there may be more or fewer arrays of suction cups 124. The gripper 123 is configured to move back and forth relative to the platform 122 and the end of the articulated arm 126. FIG. 3A depicts the gripper 123 in a distal, extended position, and FIG. 3B depicts the gripper 123 in a proximal, retracted position.

Each one of the arrays 128a, 128b, 128c may be coupled to a vacuum source so that the vacuum supply to each array 128a, 128b, 128c can be individually controlled. Alternatively, arrays 128 may all be coupled to a single vacuum source and zone control may be accomplished with a switching mechanism, such as that set forth in co-pending U.S. patent application Ser. No. 17/836,708, entitled “Vacuum Gripping System with Extending Gripper Arm,” hereby incorporated herein by reference in its entirety. In this manner, one, two, or all three arrays 128a, 128b, 128c may be activated. In the exemplary embodiment, each one of the arrays 128a, 128b, 128c has a vacuum connector 129a, 129b, 129c coupled thereto. FIG. 2 depicts vacuum hoses 127 coupled to the vacuum connectors 129.

Each one of the suction cups 124 is attached to the distal end of an extendable member 125. In this manner, the suction cups 124 and the extendable members 125 may extend and retract to accommodate packages having different surface topographies. The suction cups 124 and extendable members 125 are coupled to distribution blocks 132, which are configured to distribute the vacuum pressure from the vacuum connectors 129 through the extendable arms 125 and to the suction cups 124. The distribution blocks 132 and the extendable arms 125 are configured so that vacuum pressure is applied through the suction cups 124 whether the extendable members 125 are in an extended position or a retracted position. The extendable arms 125 extend and retract relative to the distribution blocks 132. As such, the suction cups 124, extendable members 125, and distribution blocks 132 are similar to those disclosed in U.S. patent application Ser. No. 17/836,708, previously incorporated herein by reference.

The present invention is not limited to the gripper 120 depicted in FIGS. 3A and 3B. It should be readily understood that any other kind of gripper may be used in the system 100 and that any of the grippers disclosed in U.S. patent application Ser. No. 17/836,708 may be used in the present system. For example, the gripper may include a plurality of suction cups attached to a single extendable member having a single pneumatic chamber. In another example, the gripper may include a plurality of suction cups attached to a single extendable member having a plurality of pneumatic chambers. In yet another example, the gripper may include a single suction cup attached to a single extendable member.

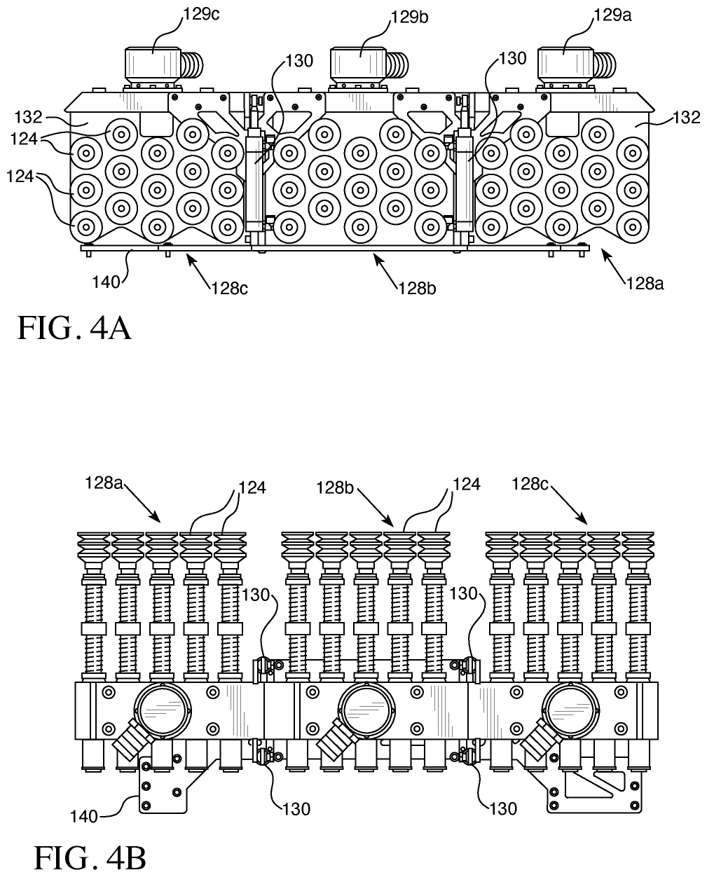

As shown in FIGS. 4A and 4B, the distribution blocks 132 are coupled to a carriage 140 that moves forward and backward relative to the platform 122. For example, the platform 122 may include tracks 136 (shown in FIGS. 3A and 3B). The carriage 140 may be operatively coupled to the platform 122 and configured to move back and forth along the tracks 136 in the platform 122. The carriage 140 may be coupled to all of the distribution blocks 132, or each distribution block 132 may have its own carriage 140 and thus be configured to move forward and backward independently of each other.

In order to pick a package, the gripper 123 is advanced distally relative to the platform 122. The gripper 123 comes into contact with the desired package and the package is suctioned to the gripper 123 using vacuum pressure. Upon contacting the package, the suction cups 124 may compress and the extendable members 125 may be pushed back to a retracted position. In this manner, the gripper 123 is configured to engage packages at different depths at the same time. The gripper 123 may then be retracted proximally relative to the platform 122 so that the package suctioned thereto is dragged onto the platform 122. The weight of the package is thus supported by the platform 122 while the package is moved to the desired location. Depending on the size of the packages, the suction cups 124 may be coupled to two or more packages at a time and the two or more packages may be located at different depths.

In one example, the gripper 123 may be configured to lift and retract the packages so that packages can be lifted up and over the lip 204 of the ULD 200. The carriage 140 may thus be configured to move the suction cups forward, backward, up, and down. The carriage 140 may include air cylinders 130 that can be actuated to lift the gripper 123 relative to the platform 122. That is, when the air cylinders 130 extend, the gripper 123 moves to a lifted position relative to the platform 122. The carriage 140 may alternatively employ any other type of lifting mechanism and the present invention is not limited to the air cylinders 130 as lifting mechanisms. For example, a servo motor may be used to actuate the lifting motion. A tilt mechanism rather than a lifting mechanism is also contemplated by the present invention.

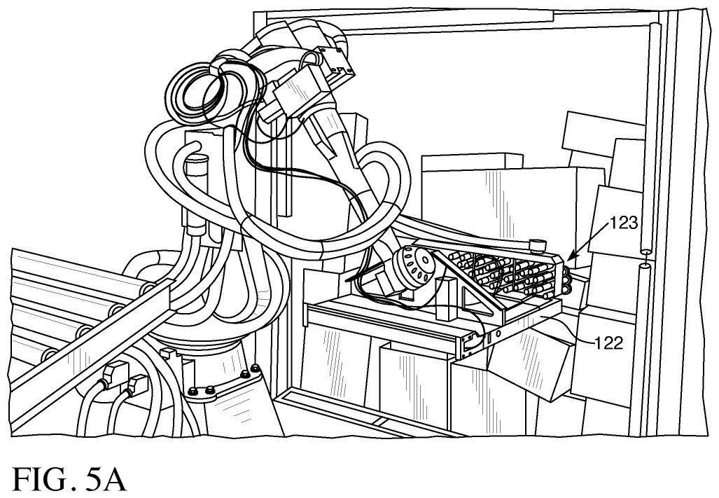

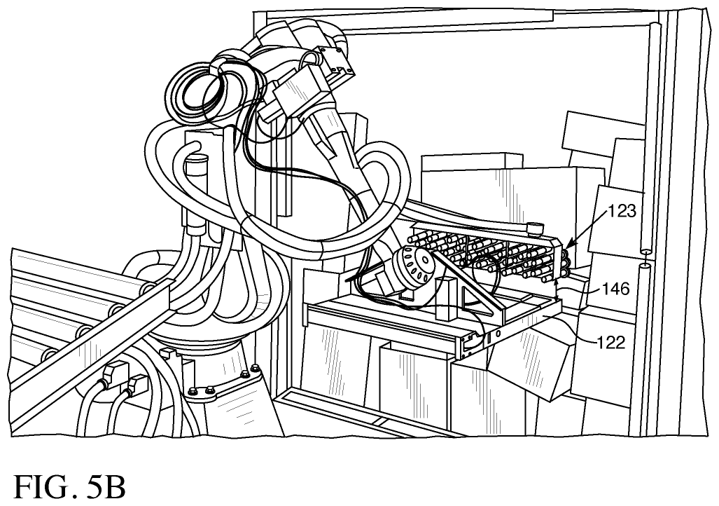

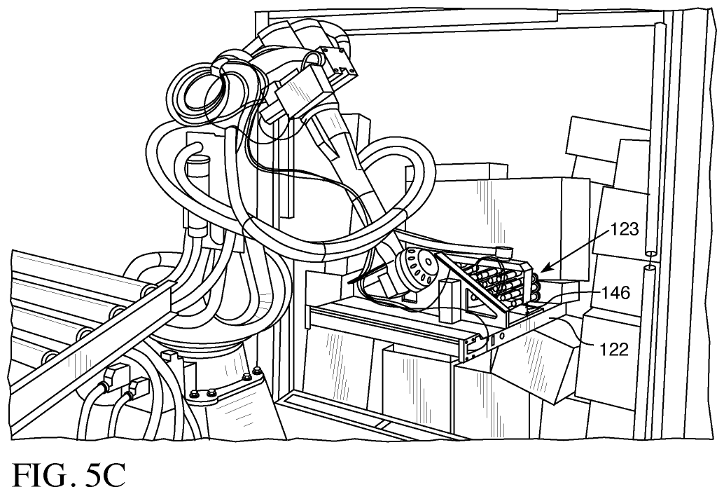

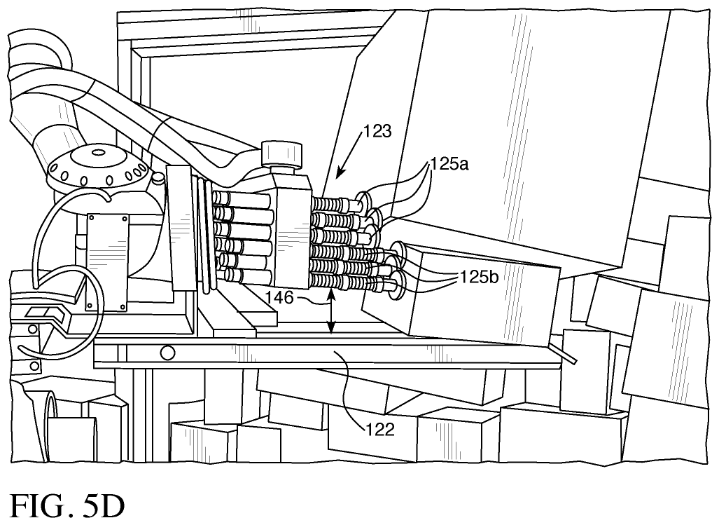

The gripper 123 may include separate pneumatic circuits for the lift and retract axis. When the gripper 123 initially comes into contact with the package or item to be moved, the pull axis is in the extended position and the lift axis is in the down position, as shown in FIG. 5A. After contacting the package or item, the lift axis is actuated upwards, as shown in FIG. 5B, thereby creating a space 146 between the gripper 123 and the top surface of the platform 122. Thus, FIG. 5B depicts the gripper 123 with packages suctioned thereto and with the lift axis in the lifted position and the pull axis in the extended position. Next, the pull axis is retracted, as shown in FIG. 5C, in order to pull the packages coupled to the gripper 123 onto the platform 122. Thus, FIG. 5C depicts the gripper 123 with the lift axis in the lifted position and the pull axis in the retracted position and with packages coupled thereto. As shown in FIG. 5D, some of the extendable arms may be retracted further than others. In particular, FIG. 5D shows extendable arms 125a in a more retracted position, while extendable arms 125b are in a more extended position. After the gripper 123 is retracted with the package(s) attached thereto, the gripper 123 may be lowered back to the down position so that the pull axis is in the retracted position and the lift axis is in the down position while the package is being transferred from the ULD to the desired place area.

In one example, the robot picking unit 114 is stationary and the ULD to be unloaded is positioned in close proximity to the robot picking unit 114. The desired location (e.g., conveyor belt) to which the packages are to be moved is also positioned in close proximity to the robot picking unit 114. Preferably, a ramp is positioned between the ULD and the desired location so that packages that fall during unloading can slide down the ramp to the desired location.

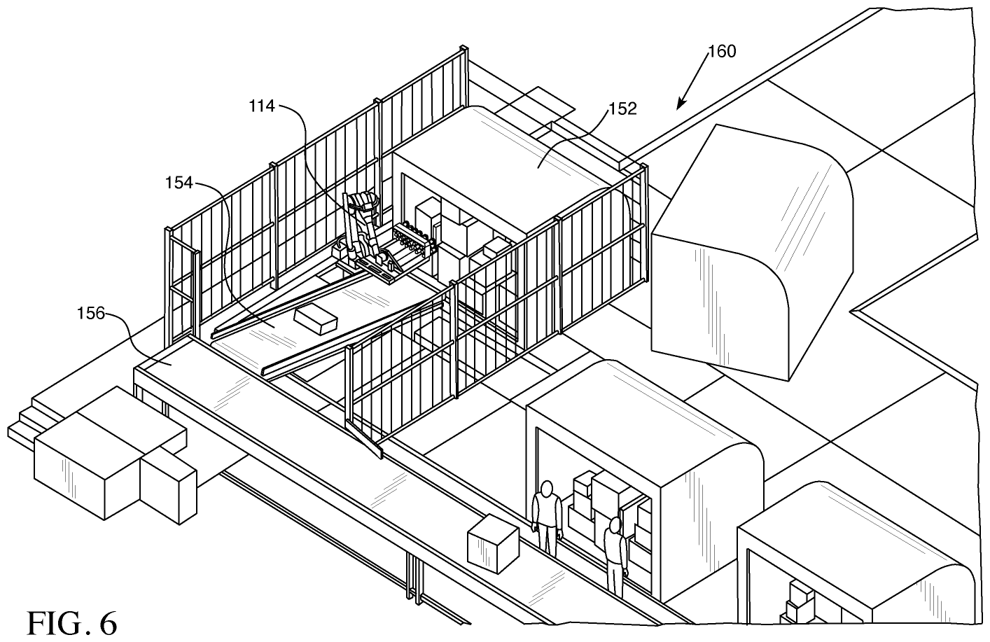

As shown in FIG. 6, an unloading station 160 includes a ULD 152 to be unloaded (or loaded), a stationary robot picking unit 114 positioned near the ULD 152, and a conveyor belt 154 adjacent to the ULD 152 and the robot picking unit 114. The positions of the ULD 152, the robot picking unit 114, and the conveyor belt 154 are preferably fixed relative to each other. The conveyor belt 154 moves the packages towards another conveyor belt 156 or other final destination. If there is a space between the ULD 152 and the conveyor belt 154, a ramp may be disposed in that space so that if packages fall during unloading, the packages slide down the ramp and onto the conveyor belt 154. An example of such a ramp 158 is depicted in FIG. 2.

Referring back to FIG. 1, robotic picking unit 114 is operable to perform robotic picking, grabbing, and/or moving of objects, as discussed previously herein. The robotic picking unit 114 generally comprises at least a robotic arm and an end effector for manipulating objects. The robotic picking unit 114 is operable to perform automated and/or semi-automated picking operations based at least in part on information associated with at least one of control system 104, vision system 106, and intervention system 108.

Data acquisition system 112 is operable to obtain data of the pick area for use by other system components in determining picking operations. Data acquisition system 112 may obtain at least one of two-dimensional data (e.g. image data) and three-dimensional data (e.g. depth data). Data acquisition system 112 may comprise at least one sensor, including but not limited to at least one of a three dimensional depth sensor, an RGB-D camera, a time of flight camera, a light detection and ranging sensor, a stereo camera, a structured light camera, a two dimensional image sensor, and an identification (e.g. barcode, QR code) scanner.

Vision system 106 is operable to identify pick data for manipulating an object associated with pick area 102, wherein the pick data can be used for controlling the robotic picking unit 114 to manipulate an identified object(s). In one aspect, vision system 106 performs at least one of object detection, object classification, pick planning, pick/object ranking, pick simulation, real-time pick verification and pick plan updating (e.g. real-time updates based on observed pick area changes). Vision system 106 is operable to perform pick planning while accounting for unique characteristics associated with unloading a container in a horizontal fashion and/or in conjunction with a unique end effector as described previously herein. For example, vision system 106 is operable to account for aspects such as the effects of gravity associated with horizontal object manipulation (e.g. friction between objects, varying torque due to different moment arms and/or object weights), object orientation relative to a vertical (and/or horizontal) plane (object angle/uprightness), whether an object supports another object and/or is leaning on another object, how movement of one object could cause others to shift position and/or orientation, etc. In one aspect, vision system 106 may operate autonomously to automatically perform the above operations. In one aspect, vision system 106 may output pick information to intervention system 108 and/or request pick information from intervention system 108, such as when vision system 106 is unable to execute at least one of the above operations or unable to achieve a threshold certainty level associated with at least one of the operations.

Intervention system 108 is operable to provide at least one of human-in-the-loop intervention and artificial intelligence intervention in order to aid vision system 106 in determining pick information and/or independently provide pick information. Intervention system 108 may comprise a remote intervention system at a location different from robotic picking site 103. In one aspect, the intervention system 108 may comprise one or more user device(s). User device(s) include, generally, a computer or computing device including functionality for communicating (e.g., remotely) over a network 150. Data may be collected from user devices, and data requests may be initiated from each user device. User device(s) may be a server, a desktop computer, a laptop computer, personal digital assistant (PDA), an in- or out-of-car navigation system, a smart phone or other cellular or mobile phone, or mobile gaming device, among other suitable computing devices. User devices may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device may be an electronic device including hardware, software, or embedded logic components or a combination of two or more such components and capable of carrying out the appropriate functions implemented or supported by the user device. For example and without limitation, a user device may be a desktop computer system, a notebook computer system, a netbook computer system, a handheld electronic device, or a mobile telephone. The present disclosure contemplates any user device. A user device may enable a network user at the user device to access network 150. A user device may enable its user to communicate with other users at other user devices.

A user device may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device may enable a user to enter a Uniform Resource Locator (URL) or other address directing the web browser to a server, and the web browser may generate a Hyper Text Transfer Protocol (HTTP) request and communicate the HTTP request to a server. The server may accept the HTTP request and communicate to the user device one or more Hyper Text Markup Language (HTML) files responsive to the HTTP request. The user device may render a web page based on the HTML files from the server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate. The user device may also include an application that is loaded onto the user device. The application obtains data from the network 150 and displays it to the user within the application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

Control system 104 is operable to coordinate operation of the various components of system 100. In one aspect, control system 104 may interface with at least one other system or unit to serve as a control and communication interface between the various system 100 components. In one aspect, control system 104 obtains input from at least one of vision system 106 and intervention system 108 and processes the input in order to determine pick information for use by robotic picking unit 114. In one aspect, control system 104 is operable to convert data and/or information obtained from the various system components into a standardized format for use by other system components. In one aspect, control system 104 generates at least one of pick information and pick instructions for use by robotic picking unit 114 in performing horizontal unloading operations of a container.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art) can communicate with each other. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. The present disclosure contemplates any suitable network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to client/user devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiments, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

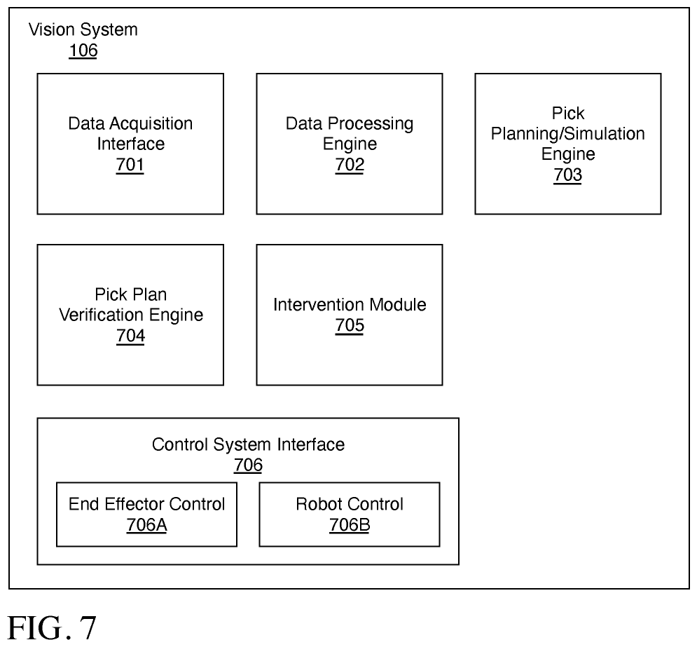

FIG. 7 illustrates an exemplary embodiment of vision system 106 for use in system 100 of FIG. 1 described above. The exemplary vision system 106 comprises data acquisition interface 701, data processing engine 702, pick planning and simulation engine 703, pick plan verification engine 704, intervention module 705, and control system interface 706 which may include end effector control 706A and robot control 706B elements.

Data acquisition interface 701 is operable to obtain data from at least one of data acquisition system 112 and robotic picking unit 114, said data associated with a pick scene associated with pick area 102. The obtained data may comprise at least one of image data, three-dimensional depth or coordinate data, robotic picking unit properties, etc. Data acquisition interface 701 may be operable to actively initiate data fetch (e.g. pull) requests to obtain data from other systems/components and/or to passively receive data sent (e.g. pushed) from other systems/components.

Data processing engine 702 is operable to process the obtained data (e.g. raw data) and convert the data into alternate data usable for performing pick planning and/or simulation. For example, data processing engine 702 may perform image processing techniques such as object detection in order to identify, differentiate and/or classify objects and/or identify container type, container dimensions, container boundaries, and/or potential obstructions associated with the container (e.g. a lip of the container having a narrower opening than the internal dimensions of the container). Exemplary object detection algorithms include, but are not limited to, You Only Look Once (YOLO), Region-based Convolutional Neural Networks (R-CNN), Fast R-CNN, Faster R-CNN, Histogram of Oriented Gradients (HOG), Region-based Fully Convolutional Network (R-FCN), Single Shot Detector (SSD), Spatial Pyramid Pooling (SPP-net), as well as other image processing and computer vision techniques including, but not limited to, image registration, image segmentation, plane segmentation, template matching, edge detection, feature detection, and planar and linear transformations. In one aspect, object detection comprises determining at least one object feature including, but not limited to, object size, object shape, object position relative to other objects, object position relative to the container (e.g. near top, near bottom, etc.), whether an object supports other objects, whether an object is supported by other objects, orientation of an object (e.g. angled, flat, upright, etc.), and/or at least one container feature such as container type, container dimensions (including lip dimensions and/or container opening dimensions), etc. Once the raw data (e.g. image data, depth data) has been processed and converted into object data associated with the pick scene, data processing engine 702 may provide the object data to at least one of path planning/simulation engine 703 and intervention module 705.

Pick planning and simulation engine 703 is operable to perform at least one of pick planning and pick simulation based on data associated with robotic picking site 103. In one aspect, pick planning and simulation engine 703 obtains object data from data processing engine 702 and analyzes the data to determine at least one pick order for picking objects for unloading purposes. In one aspect the pick order may be based on at least one object feature including, but not limited to, object size, object shape, object position relative to other objects, object position relative to the container (e.g. near top, near bottom, etc.), whether an object supports other objects, whether an object is supported by other objects, orientation of an object (e.g. angled, flat, upright, etc.), and/or at least one container feature such as container type, container dimensions (including lip dimensions and/or container opening dimensions), etc. In one aspect, one or more features may be prioritized ahead of other features such that a hierarchy of object features is used in determining a pick order. In one aspect, multiple features may be considered simultaneously or given equal priority in the hierarchy. In one aspect, the hierarchy of object features may be learned and/or updated over time, such as via artificial intelligence and/or machine learning (e.g. reinforcement learning). In one aspect, pick planning and simulation engine 703 is operable to account for the need to partially pull an object outward (horizontally), then move the object towards the center (or midline) of the container opening (e.g. in order to avoid the object colliding with a container lip), then again move outward (horizontally) to complete the process of unloading the object from the container. In one aspect, pick planning and simulation engine 703 may plan the initial movement to partially pull an object outward to comprise control for activating end effector (e.g. those described above including but not limited to grippers such as suction cups) to pull the object on to the platform or spatula of the robotic arm end effector, then control for moving the robotic arm and associated end effector to complete the unloading process. In one aspect, the pick plan comprises planning a combined control of the end effector and robotic arm to engage with an object in order to execute a lift and drag type movement of the object to pull the object onto a platform of the end effector. In one aspect, end effector and robotic arm movement may occur simultaneously or independently throughout the unloading process.

In one aspect, pick planning and simulation engine 703 analyzes one or more determined pick orders in order to simulate the effects of each pick order in order to identify a preferred pick order. In one aspect, pick planning and simulation engine 703 may rank each identified object based on one or more determined features wherein the ranking serves as an indication of a predicted preferred order for unloading the objects. In one aspect, the pick planning and simulation engine 703 simulates the outcome, on a pick by pick basis, using the determined ranking, in order to identify any potential flaws or issues with a given pick and/or pick order. In one aspect, ranking comprises identifying a first ranked object (e.g. highest rank), simulating the outcome associated with picking this object, re-analyzing the remaining objects (assuming the first highest ranked object is no longer present) in order to determine the next object having the highest rank and iterating the process for a plurality of objects. In one aspect, pick planning and simulation engine 703 evaluates simultaneous picking of multiple objects such as two stacked objects as depicted in FIG. 5 above, however other numbers and/or orientations of objects may be considered by pick planning and simulation engine 703. For example, pick planning and simulation may consider simultaneous picking of multiple adjacent objects or non-adjacent objects at approximately the same horizontal level such that they could be pulled onto the spatula or platform at substantially the same time.

Pick plan verification engine 704 is operable to evaluate a current status of the pick area 102 in order to determine if an existing pick plan remains appropriate for automated picking operations. In one aspect, pick plan verification engine 704 performs a check to ensure that the next object to be picked appears to be in an expected location in accordance with the established pick plan. In one aspect, pick plan verification engine 704 performs a scene check after a pick is executed in order to ensure that the remaining objects to be unloaded are arranged as expected. For example, pick plan verification engine 704 may compare data from data acquisition system 112 (e.g. image data) obtained prior to executing a pick and after executing a pick in order to ensure that the only change present is associated with the object that was picked (e.g. no other objects fell, shifted, etc.). Pick plan verification engine 704 may determine that a current pick plan is no longer appropriate for a give pick scenario and trigger pick planning and simulation engine 703 to recompute a pick plan based on newly obtained pick area data. For example, if pick plan verification engine 704 determines that a pick scene changed by an unexpected amount and/or identifies changes in unexpected locations, pick plan verification engine 704 may generate a flag indicating the need to re-evaluate an existing pick plan.

Intervention module 705 is operable to interface with at least one intervention system, such as intervention system 108, in order to at least one of provide pick information to intervention system and obtain pick information from intervention system. In one aspect, intervention module 705 obtains confirmation of a vision system generated pick plan. In one aspect, intervention module 705 obtains pick information from an intervention system such as when vision system is unable to automatically determine pick information or unable to determine pick information above a confidence threshold.

Control system interface 706 is operable to provide pick information to a control system, e.g. control system 104, for use by control system in controlling robotic picking operations. In one aspect, control system interface 706 provides pick information in the form of pick coordinates. Control system interface 706 may be comprised of end effector control 706A and robot control 706B which respectively control the end effector (e.g. gripper) and a robot (e.g. a robotic arm of robotic picking unit). Control system interface 706 may provide coordinated control, through end effector control 706A and robot control 706B, of the end effector and a robot (e.g. robotic arm) to perform actions independently and/or simultaneously in accordance with a pick plan. End effector control 706A is operable to provide control information for an end effector such as end effector 120 discussed above to at least one of interface with, lift and drag/pull objects onto a platform during an unloading operation. End effector control 706A is operable to provide control information associated with different arrays of suction cups or sub-portions thereof to be used as part of a given picking operation according to a pick plan. In one aspect, the end effector control information is based on at least one of the object features. For example, object size and/or may determine the number and location of suction cups to be activated in order to interface with the object to be unloaded. Robot control 706B is operable to provide control information associated with movement of robotic picking unit, such as movement of a robotic arm in order to position end effector in the correct positions and/or orientations throughout the unloading process. Although described herein with particular emphasis on gripper control such as suction cups, other end effectors may be controlled, including, but not limited to jaws, claws, pincers, and the like for use in a lift and/or drag/pull manipulation of objects.

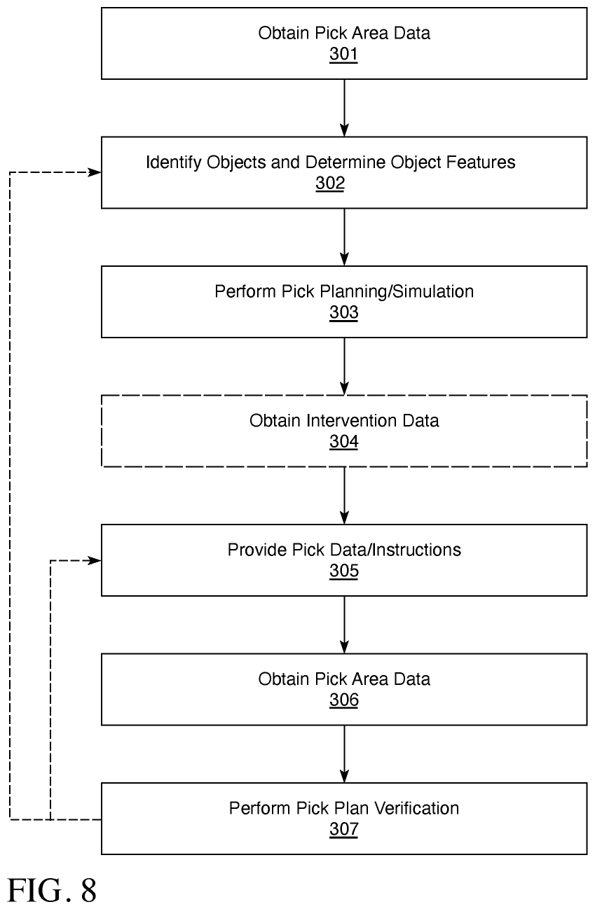

FIG. 8 illustrates an exemplary process for performing picking operations to unload a container such as a ULD, box truck, or the like. The process may comprise obtaining pick area data 301, identifying objects and determining object features 302, performing pick planning and/or simulation 303, optionally obtaining intervention data 304, providing pick data and/or pick instructions, obtaining pick area data 306, and performing pick plan verification 307. Additional steps may be included, the order of the steps may be rearranged, and one or more steps may be excluded, as necessary, as would be apparent to one of ordinary skill in the art depending on a particular application or scenario faced

At step 301, the process comprises obtaining pick area data 301 including at least data associated with container(s) and/or object(s) in the pick area. Pick area data may comprise at least one of two-dimensional and three-dimensional data of a pick area. Pick area data may comprise at least one of image data and depth data. Pick area data may be obtained via a data acquisition system, such as data acquisition system 112 described above.

At step 302, the process comprises processing the obtained pick area data to at least one of identify objects and determine object features. Identifying objects and their associated features may comprise image processing and computer vision techniques such as those described above in association with data processing engine 702. Object features may comprise at least one of object size, object shape, object position relative to other objects, object position relative to the container (e.g. near top, near bottom, etc.), whether an object supports other objects, whether an object is supported by other objects, orientation of an object (e.g. angled, flat, upright, etc.), and/or at least one container feature such as container type, container dimensions (including lip dimensions and/or container opening dimensions), etc, as discussed above.

At step 303, the process comprises performing at least one of pick planning and pick simulation. Pick planning and simulation may be performed as described above in association with pick planning and simulation engine 703. In one aspect, pick planning may comprise ranking of objects based on object features wherein the ranking indicates at least one of a predicted next best pick and predicted best pick order for a plurality of objects. In one aspect, pick planning comprises simulating a predicted outcome associated with picking one or more objects and uses the simulated outcome in order to perform pick planning (e.g. ranking of objects).

At step 304, the process comprises optionally obtaining intervention data. Intervention data generally comprises user input associated with pick information including, but not limited to, at least one of user identified pick objects, user confirmation of pick objects (such as those identified by an automated vision system), and pick order input and/or confirmation. Intervention data may be obtained from an intervention system, such as intervention system 108. Intervention data may be obtained via an intervention module, such as intervention module 705 as described above.

At step 305, the process comprises providing at least one of pick data and pick instructions. In one aspect, pick data comprises pick object information to be used in controlling a robotic picking unit including controlling at least one of a robot and an end effector. In one aspect, pick data comprises pick coordinates. In one aspect, pick data may be converted into pick instructions by at least one of a vision system, a control system and a robotic picking unit, such as those described above. In one aspect pick instructions comprise instructions for direct control of a robot. Providing pick data and/or instructions may be provided in accordance with control system interface 706 as discussed above.

At step 306, the process comprises obtaining pick area data. The pick area data may be obtained in the same fashion as step 301 above, however occurring at a later time. In one aspect, step 306 may occur at a fixed amount of time after at least one of the previous steps. In one aspect, step 306 may occur after an expected change in the pick area, such as an object being at least one of picked and moved, such as by a robotic picking unit in accordance with the pick data and/or pick instructions.

At step 307, the process comprises performing pick plan verification. In one aspect, plan verification comprises comparing pick area data from step 306 with pick area data from step 301. In one aspect, the comparing comprises determining an amount of difference between the two data sets. For example, if the pick area data comprises image data, plan verification may comprise comparing the image data by performing image subtraction. In one aspect, comparing comprises determining that the difference is at least one of within a threshold amount or exceeds a threshold amount. In one aspect, plan verification comprises comparing pick area data from steps 306 and 301 in order to determine that the pick area data changed in a location where change was expected (e.g. where an identified object was picked and moved). In one aspect, comparing comprises determining that the change(s) present in the pick area data are associated with a location(s) where change was expected and/or that no change (or change below a threshold amount) occurred outside of the location where change was expected.

The process may return to at least one of steps 302 (to process the newly obtained pick area data to at least one of identify objects and object features and determine a new pick plan and corresponding pick data and/or pick instructions) and 305 (to provide pick data and/or instructions associated with a previous pick plan which, via the verification step, has been determined to remain valid).

Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

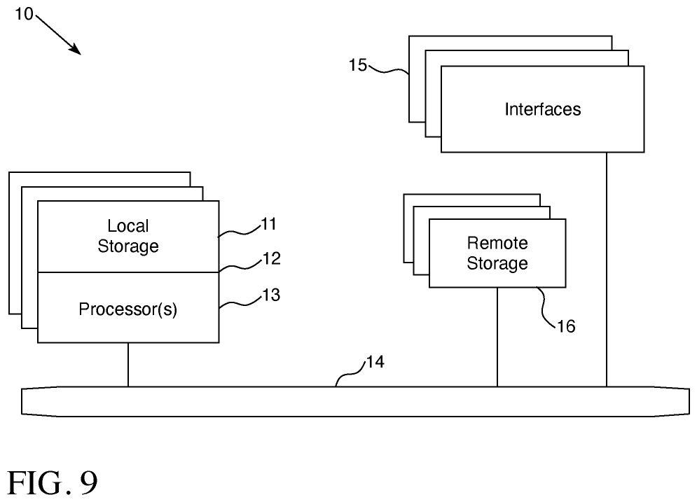

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, controllers, components or the like may be and/or comprise hardware and/or software as described herein. For example, at least the intervention system 108, control system 104, vision system 106 and subcomponents thereof may be and/or comprise computing hardware and/or software as described herein in association with FIGS. 9-12. Furthermore, any of the above mentioned systems, units, modules, engines, controllers, components, interfaces or the like may use and/or comprise an application programming interface (API) for communicating with other systems units, modules, engines, controllers, components, interfaces or the like for obtaining and/or providing data or information.

Referring now to FIG. 9, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 9 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

In some embodiments, systems may be implemented on a standalone computing system.

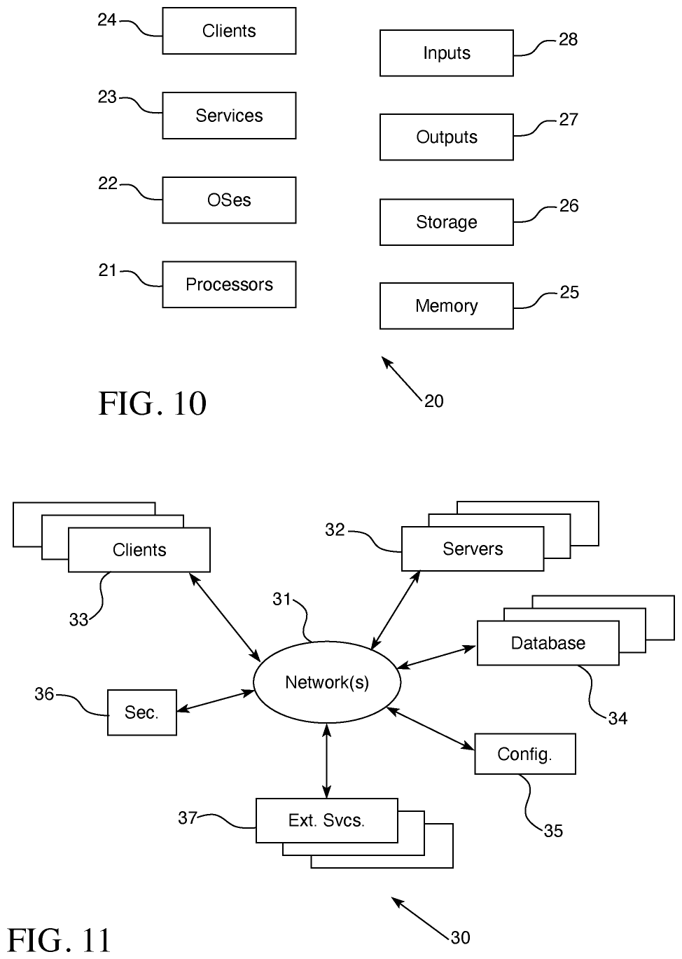

Referring now to FIG. 10, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 9). Examples of storage devices 26 include flash memory, magnetic hard drive, CD-ROM, and/or the like.

In some embodiments, systems may be implemented on a distributed computing network, such as one having any number of clients and/or servers. Referring now to FIG. 11, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 10. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

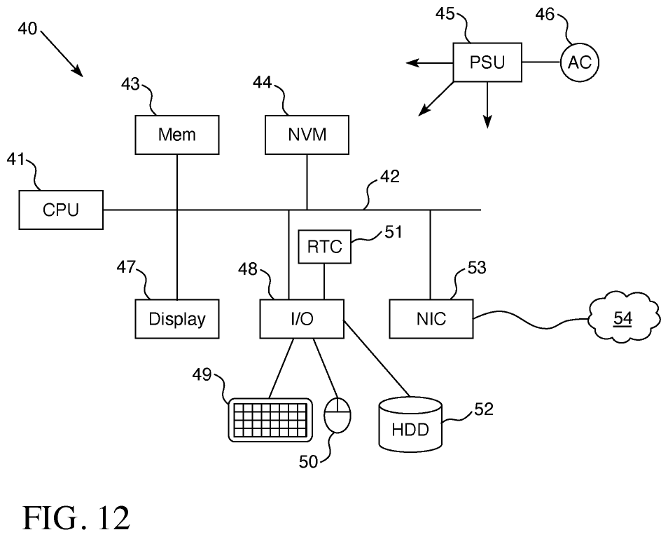

FIG. 12 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

It is thus understood that the invention is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described invention.

Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. An end effector configured for attaching to a robotic arm, the end effector comprising:
a gripper configured for being in fluid communication with a vacuum source;
a carriage, wherein the gripper is coupled to the carriage; and
a platform having a distal end and a proximal end, wherein the proximal end is configured for being coupled to the robotic arm,
wherein the carriage is operatively coupled to the platform and is configured to move back and forth between the distal and proximal ends of the platform.

2. The end effector of claim 1, wherein the carriage is further configured to move the gripper upwards relative to the platform so that the gripper is in a lifted position relative to the platform.

3. The end effector of claim 2, wherein the carriage comprises an actuator that is configured to move the gripper upwards to the lifted position.

4. The end effector of claim 3, wherein the actuator comprises at least one of: a pneumatic air cylinder and a servo motor.

5. The end effector of claim 4, wherein the actuator comprises a plurality of pneumatic air cylinders that are configured to extend to move the gripper upwards to the lifted position.

6. The end effector of claim 1, wherein the gripper comprises a plurality of suction cups coupled to a respective plurality of extendable arms.

7. The end effector of claim 6, wherein the extendable arms are configured to extend and retract relative to the carriage.

8. The end effector of claim 1, wherein the platform comprises a track and the carriage is operatively coupled to the track, and wherein the carriage is configured to move back and forth within the track.

9. The end effector of claim 1, wherein the gripper is configured for engaging a package, and wherein the carriage is configured for dragging the package onto the platform while the package is engaged by the gripper.

10. The end effector of claim 2, wherein the gripper is configured for engaging a package, and wherein the carriage is configured for lifting the gripper and dragging the package onto the platform while the package is engaged by the gripper.
